(19) United States
(12) Patent Application Publication
(10) Pub. No.: US 2019/0009876 A1
(43) Pub. Date: Jan. 10, 2019

(54) AIRCRAFT

(71) Applicant: PANASONIC INTELLECTUAL PROPERTY MANAGEMENT CO., LTD., Osaka (JP)

(72) Inventors: Masayuki TOYAMA, Kanagawa (JP); Naoto YUMIKI, Osaka (JP); Atsuhiro TSUJI, Osaka (JP); Hiroyuki MATSUMOTO, Tokyo (JP)

(21) Appl. No.: 16/116,383

(22) Filed: Aug. 29, 2018

Related U.S. Application Data
(63) Continuation of application No. PCT/JP2017/006276, filed on Feb. 21, 2017.

(30) Foreign Application Priority Data
Mar. 10, 2016 (JP) 2016-047500

(51) Int. Cl. B64B 1/30; B64B 1/58; B64B 1/26; B64C 27/20; B64C 27/00; B64C 39/02

(52) U.S. Cl. CPC B64B 1/30; B64B 1/58; B64B 1/26; B64C 27/20; B64C 27/006; B64C 2201/146; B64C 2201/024; B64C 2201/022; B64C 2201/042; B64C 2201/20; B64C 2201/145; B64C 39/024

(57) ABSTRACT

An aircraft includes: a plurality of rotor units each including a propeller and a motor that drives the propeller; a plurality of shock absorbers provided to the plurality of rotor units; and a main body to which the plurality of rotor units attach. The plurality of rotor units and the plurality of shock absorbers are attachable to and detachable from the main body.

### CROSS REFERENCE TO RELATED APPLICATIONS

This application is a U.S. continuation application of PCT International Patent Application Number PCT/JP2017/006276 filed on Feb. 21, 2017, claiming the benefit of priority of Japanese Patent Application Number 2016-047500 filed on Mar. 10, 2016, the entire contents of which are hereby incorporated by reference.

### BACKGROUND

### 1. Technical Field

The present disclosure relates to an aircraft including a plurality of rotor units.

### 2. Description of the Related Art

Japanese Unexamined Patent Application Publication No. 2011-046355 discloses an aircraft including a plurality of rotor units that each include a propeller. An aircraft such as the one disclosed in Japanese Unexamined Patent Application Publication No. 2011-046355 is referred to as a multicopter or drone.

### SUMMARY

The present disclosure provides an aircraft that improves flying stability by reducing influence from contact, and improves transportability despite inclusion of a plurality of rotor units.

An aircraft according to the present disclosure includes: a plurality of rotor units each including a propeller and a motor that drives the propeller; a plurality of shock absorbers provided to the plurality of rotor units; and a main body to which the plurality of rotor units attach. The plurality of rotor units and the plurality of shock absorbers are attachable to and detachable from the main body.

With an aircraft according to the present disclosure, it is possible to improve flying stability upon contact, and improve transportability despite inclusion of a plurality of rotor units.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a perspective view of the aircraft according to Embodiment 1 from above;

FIG. 2 is a plan view of the aircraft illustrated in FIG. 1 from above;

FIG. 3 is a cross-sectional side view of the aircraft taken at line III-III in FIG. 2;

FIG. 4 is an enlarged perspective view of a first type of rotor unit among the four rotor units included in the aircraft illustrated in FIG. 2;

FIG. 5 is an enlarged perspective view of a second type of rotor unit among the four rotor units included in the aircraft illustrated in FIG. 2;

FIG. 6 is a block diagram illustrating components included in the aircraft according to Embodiment 1;

FIG. 7 is a perspective view illustrating the five separable units that constitute the aircraft illustrated in FIG. 1 in a state in which they are stacked one on top of another;

FIG. 8 is a plan view of the five stacked units illustrated in FIG. 7 from above;

FIG. 9 is an enlarged perspective view of the coupling part of the first arm part and the second arm part, illustrated in FIG. 3;

FIG. 10 is an enlarged perspective view of another example of the coupling part of the first arm part and the second arm part illustrated in FIG. 3 similar to the view of FIG. 9;

FIG. 11 is an enlarged perspective view of yet another example of the coupling part of the first, arm part and the second arm part illustrated in FIG. 3, similar to the view of FIG. 9;

FIG. 12 is a plan view of the aircraft according to Embodiment 2, similar to the view of FIG. 2;

FIG. 13 is a cross-sectional side view of the aircraft taken at line XIII-XIII in FIG. 12;

FIG. 14 is a cross sectional side view of the aircraft according to Embodiment 3, similar to the view of FIG. 3;

FIG. 15 is a block diagram illustrating components included in the aircraft according to Embodiment 3;

FIG. 16 is a cross sectional side view of a variation of the aircraft according to Embodiment 1, similar to the view of FIG. 3; and

FIG. 17 is a perspective view of another variation of an aircraft according to Embodiment 1, similar to the view of FIG. 1.

### DETAILED DESCRIPTION OF THE EMBODIMENTS

Hereinafter, embodiments will be described in detail with reference to the drawings when appropriate. However, unnecessarily detailed description may be omitted. For example, detailed descriptions of well-known matters or descriptions of components that are substantially the same as components described previous thereto may be omitted. This is to avoid unnecessary redundancy and provide easy-to-read descriptions for those skilled in the art. Moreover, in the following descriptions of the embodiments, language accompanied by the terminology “approximately” and “substantially” as used in, for example, “substantially parallel” and “substantially perpendicular,” is used. For example, “substantially parallel” includes, in addition to exactly parallel, essentially parallel, that is to say, for example, includes a margin of error of about a few percent. This also applies to other language accompanied by “approximately” or “substantially”. Note that the accompanying drawings and subsequent description are provided by the inventors to facilitate sufficient understanding of the present disclosure by those skilled in the art, and are thus not intended to limit the scope of the subject matter recited in the claims.

### Embodiment 1

### (1-1. Aircraft Configuration)

### (1-1-1. Overall Aircraft Configuration)

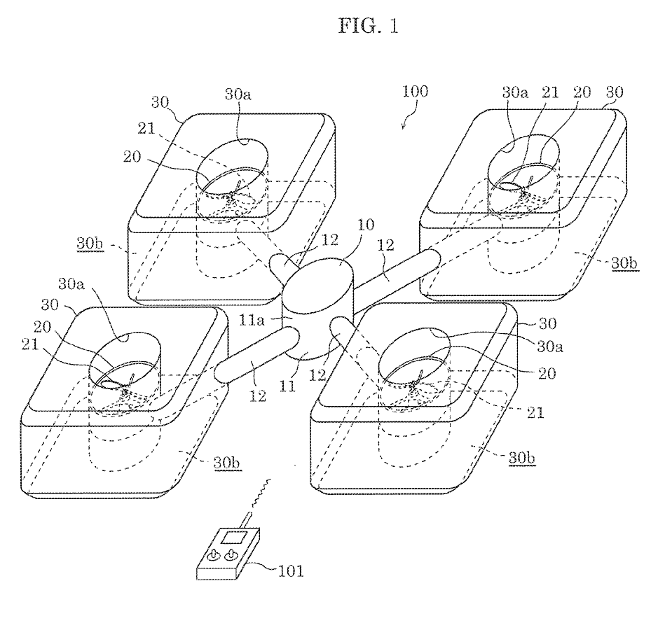

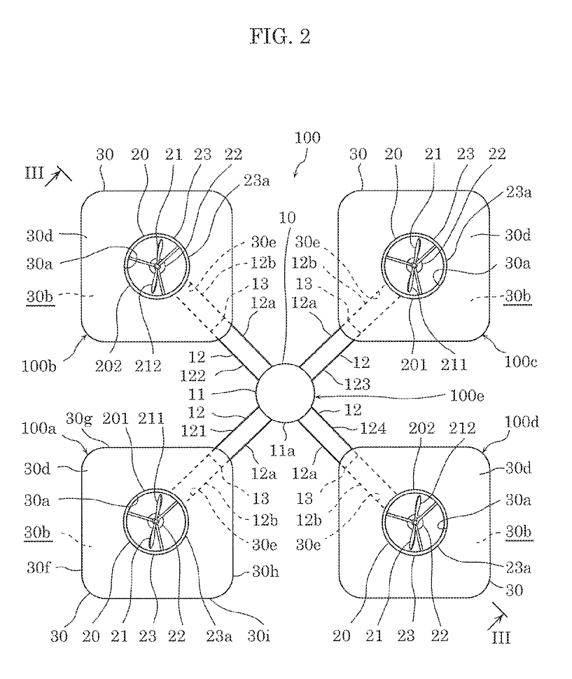

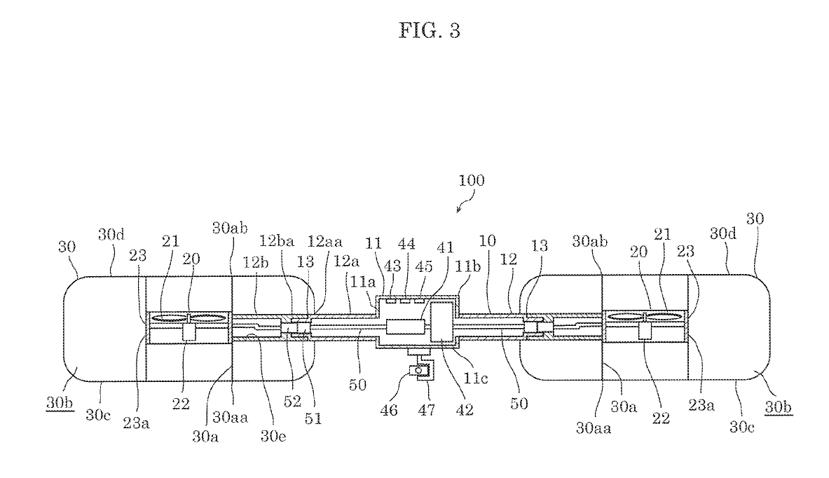

Hereinafter, the overall configuration of aircraft 100 according to Embodiment 1 will be described with reference to FIG. 1 through FIG. 3. FIG. 1 is a perspective view of aircraft 100 according to Embodiment 1 from above. FIG. 2 is a plan view of aircraft 100 illustrated in FIG. 1 from above. FIG. 3 is a cross-sectional side view of aircraft 100 taken at line III-III illustrated in FIG. 2. Note that “above” aircraft 100 refers to “above” when aircraft 100 is in a normal flying orientation.

As illustrated in FIG. 1 through FIG. 3, aircraft 100 according to this embodiment includes frame 10, four rotor units 20 provided to frame 10, and hollow balloons 30, which are shock absorbers, respectively attached to rotor units 20. In this embodiment, aircraft 100 wirelessly communicates with steering controller 101 disposed apart from aircraft 100, and operates in accordance with a command signal transmitted from steering controller 101, but this example is not limiting. Frame 10 includes frame main body 11 having the shape of a cylinder with both ends closed, and four hollow rod-shaped arms 12. The four arms 12 extend radially outward from the outer circumferential surface of cylindrical lateral wall 11a of frame main body 11. The four arms 12 are disposed approximately equidistant from each other along the outer circumferential direction of lateral wall 11a of frame main body 11, and collectively have a plan view shape of a cross. Note that a plan view shape refers to the shape as seen when aircraft 100 is viewed looking down the axis of the cylindrical frame main body 11. The four units 20 are attached to the distal ends of the four arms 12, respectively. Accordingly, each of the four rotor units 20 is disposed in a different one of four spaces delimited by lines that intersect at approximately 90 degrees at a point centered on frame main body 11. Note that the arrangement of the four rotor units 20 is not limited to the above example. Here, frame 10 is one example of the main body of the aircraft.

Each rotor unit 20 includes propeller 21, motor 22 that rotationally drives propeller 21, and cylindrical rotor frame 23 that supports motor 22 therein. Each rotor frame 23 is fixed to a different one of arms 12. The four rotor units 20 are disposed such that the planes of rotation of propellers 21 are all oriented in the same direction, that is to say, such that the axes of rotation of propellers 21 are substantially parallel with one another. Balloons 30 are attached on the cylindrical outer circumferential surface 23a of each rotor frame 23 so as to surround outer circumferential surface 23a. Balloon 30 has a bag-shaped structure that is capable of inflating and deflating. When filled with gas, balloon 30 inflates into a cuboid shape. Each balloon 30 has approximately the same external shape and approximately the same external size when inflated.

### (1-1-2. Rotor Unit)

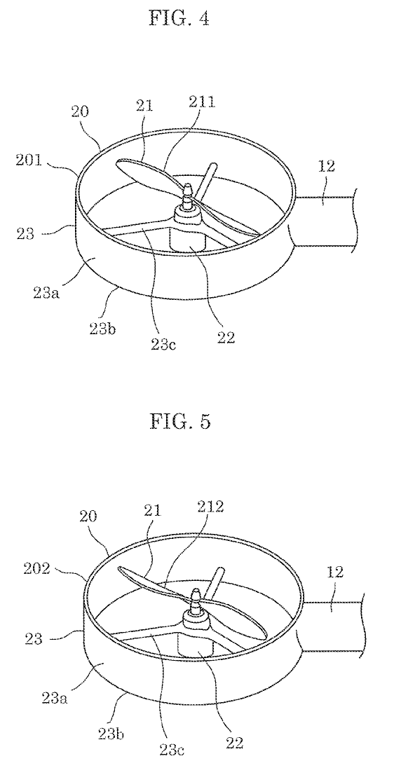

Next, the configuration of rotor units 20 will be described with reference to FIG. 1, FIG. 2, FIG. 4, and FIG. 5. FIG. 4 is an enlarged perspective view of a first type of rotor unit 201 among the four rotor units 20 included in aircraft 100 illustrated in FIG. 2. FIG. 5 is an enlarged perspective view of a second type of rotor unit 202 among the four rotor units 20 included in aircraft 100 illustrated in FIG. 2.

As illustrated in FIG. 1, FIG. 2, FIG. 4, and FIG. 5, the four rotor units 20 include two first rotor units 201 which are the first type of rotor units and two second rotor units 202 which are the second type of rotor units. As illustrated in FIG. 2 in particular, first rotor units 201 and second rotor units 202 are alternately disposed along the outer circumference of lateral wall 11a of frame main body 11. In other words, the two first rotor units 201 are respectively provided to, from among the four arms 12 of frame 10, the two arms 121 and 123 positioned opposite each other across frame main body 11. Furthermore, the two second rotor units 202 are respectively provided to, from among the four arms 12, the two arms 122 and 124 positioned opposite each other across frame main body 11. Note that, as illustrated in FIG. 2, arms 121, 122, 123, and 124 are disposed clockwise around frame main body 11 in the listed order.

As illustrated in FIG. 4 and FIG. 5, first rotor units 201 and second rotor units 202 each have the same configuration except for the configuration of propeller 21. Rotor frames 23 of rotor units 201 and 202 each include cylindrical part 23b having a slim structure in the axial direction, and a plurality of rod-shaped support arms 23c that extend radially inward from the inner circumferential surface of cylindrical part 23b. Cylindrical part 23b and support arms 23c are integral. Note that in this embodiment, each rotor frame 23 includes three support arms 23c, but the number of support arms 23c is not limited to this example. Motors 22 of rotor units 201 and 202 are each disposed in the inner space defined by cylindrical part 23b and supported in a position on the central axis of cylindrical part 23b by support arms 23c so as to be fixed to cylindrical part 23b. Moreover, the outer circumferential surface of cylindrical part 23b of each rotor unit 201 and 202 defines outer circumferential surface 23a, and an end of aria 12 is joined to outer circumferential surface 23a.

First propeller 211, which is a first type of propeller among propellers 21, is attached to the rotary drive shaft of motor 22 in first rotor unit 201. Second propeller 212, which is a second type of propeller among propellers 21, is attached to the rotary drive shaft of motor 22 in second rotor unit 202. Each first propeller 211 and second propeller 212 is disposed inside a different cylindrical part 23b such that its axis of rotation is aligned with the axis of cylindrical part 23b. Each first propeller 211 and second propeller 212 is disposed so as to be positioned above motor 22 when aircraft 100 is in a normal flying orientation. In this embodiment, each first propeller 211 and second propeller 212 is a two-bladed propeller. Note that the number of blades in each of first propeller 211 and second propeller 212 is not limited to two.

Moreover, the blades in first propeller 211 and the blades in second propeller 212 twist in opposite directions. Stated differently, the blades in first propeller 211 and the blades in second propeller 212 have inverted structures. Accordingly, when first propeller 211 and second propeller 212 rotate in a clockwise direction in FIG. 2, first propeller 211 generates upward thrust, and second propeller 212 generates downward thrust. Similarly, when first propeller 211 and second propeller 212 rotate in a counter direction, first propeller 211 generates downward thrust, and second propeller 212 generates upward thrust.

With first rotor units 201 and second rotor units 202 configured as described above, both when causing aircraft 100 to ascend and when causing aircraft 100 to descend, first propellers 211 and second propellers 212 rotate in opposite directions. With this, the counter torque imparted on frame 10 when first propellers 211 are rotationally driven and the counter torque imparted on frame 10 when second propellers 212 are rotationally driven cancel each other out.

Note that in this embodiment, one propeller 21 is exemplified as being provided to the rotary drive shaft of motor 22 in each rotor unit 20, but two or more propellers 21 may be provided. When two propellers 21 are provided to the rotary drive shaft of motor 22, the two propellers 21 may be configured so as to rotate in opposite directions. In other words, the two propellers 21 may be contra-rotating propellers. In such cases, the counter torque that these two propellers 21 impart on rotor frame 23 cancel each other out.

### (1-1-3. Balloon)

Next, the configuration of balloon 30 will be described. As illustrated in FIG. 1 through FIG. 3, balloons 30 attached to rotor frames 23 of rotor units 20 in aircraft 100 have a bag-shaped structure, and each define therein chamber 30b, which is an airtight space. When chamber 30b changes in volumetric capacity by being inflated or deflated, balloon 30 also inflates or deflates. In other words, chamber 30b and balloon 80 inflate and deflate together. Each balloon 30 is disposed on outer circumferential surface 23a of a different rotor frame 23 so as to surround the entire circumference of outer circumferential surface 23a.

Gas is injected into chamber 30b of each balloon 30 to inflate balloon 30. The gas used may be vaporized or a mixture of gas and liquid. The gas used has a lower specific gravity than the atmosphere, such as helium gas. This allows balloon 30 make frame 10, that is to say, aircraft 100 buoyant relative to the air. As a result, less output is required of motor 22 in rotor unit 20 when flying aircraft 100. Note that the type of gas used is not limited to the above example. For example, when balloon 30 need not produce buoyancy relative to the air, an atmospheric gas may be used, and gas having a higher specific gravity than the atmosphere, such as carbon dioxide, may be used. In such cases, balloon 30 can function as a shock absorber that acts as a cushion for aircraft 100. This will be described in detail later.

Balloon 30 is made of a material that is in sheet form and is flexible. For example, balloon 30 may be made of a supple sheet material, such as polyvinyl chloride. Unwoven fabric may be used as the above-described sheet material for balloon 30. Furthermore, balloon 30 may be made of an elastic sheet material, such as polyurethane. Still furthermore, balloon 30 may be made of a highly stretchable sheet material, such as rubber. Balloon 30 that is made of sheet material as described above and filled and inflated with gas can function as a shock absorber that acts as a cushion for aircraft 100.

In this embodiment, when inflated with gas, the external shape of balloon 30 is a flattened cuboid. Cylindrical through-hole 30a passes through each balloon 30. Through-hole 30a opens at open ends 30aa and 30ab in opposing surfaces 30c and 30d, respectively. The two surfaces 30c and 30d are positioned on balloon 30 in a direction in which balloon 30 is flattened. Note that the distance between surfaces 30c and 30d is shorter than the distance between each of the other two pairs of opposing surfaces. Chamber 30b of balloon 30 defines a single continuous space that circumferentially surrounds through-hole 30a on the inner side of the sheet material.

Through-hole 30a has an inner diameter that matches the outer diameter of rotor frame 23 of rotor unit 20. The entire rotor unit 20 is disposed within through-hole 30a. Rotor unit 20 is disposed such that the axis of rotation of propeller 21 and the rotary drive shaft of motor 22 are aligned with the axis of through-hole 30a. In other words, in regard to the height of the cylindrical rotor frame 23 in the up-and-down direction, which is the height of cylindrical rotor frame 23 measured along the axis of rotor frame 23, rotor unit 20 is entirely laterally covered by balloon 30, throughout a region extending beyond the top and bottom ends of rotor frame 23. Each arm 12 of frame 10 extends from the inner circumferential wall surface of through-hole 30a, and passes through and out of balloon 30. Chamber 30b of balloon 30 is separated from rotor frame 23 and arm 12 by the sheet material forming balloon 30.

As described above, through-hole 30a opens at open ends 30aa and 30ab, and houses therein rotor unit 20. Through-bole 30a having such a configuration is a ventilation hole in balloon 30 for rotor unit 20. Propeller 21 of rotor unit 20 rotates and produces airflow that passes through through-hole 30a and rotor unit 20. This airflow enters through-hole 30a from open end 30aa or 30ab, passes through through-hole 30a and rotor unit 20, and then exits through-hole 30a from open end 30ab or 30aa. Accordingly, when propeller 21 is rotating, rotor unit 20 thrusts aircraft 100 by generating thrust in a direction from one open end 30aa of through-hole 30a to the other open end 30ab, or in the opposite direction. When aircraft 100 is in its normal flying orientation, open end 30aa is located on the bottom end of through-hole 30a, and open end 30ab is located on the top end of through-hole 30a.

Note that the external shape of balloon 30 when inflated is not limited to a substantial cuboid shape. The external shape of balloon 30 when inflated may be, for example, a sphere, an ellipsoid, a columnar shape, a polyhedron, or a donut shape, may be any combination of at least two of a sphere, an ellipsoid, a columnar shape, a polyhedron, and a donut shape, and may be any other shape. The external shape of balloon 30 when inflated may be a shape defined by aerodynamic, smooth surfaces. Furthermore, balloon 30 need not have a shape that surrounds the entire circumference of outer circumferential surface 23a of rotor frame 23; balloon 30 may have a shape that conforms to a portion of outer circumferential surface 23a. Alternatively, balloon 30 may not cover rotor frame 23, but rather be attached directly or indirectly to or disposed on rotor unit 20.

### (1-1-4. Frame and On-Board Components)

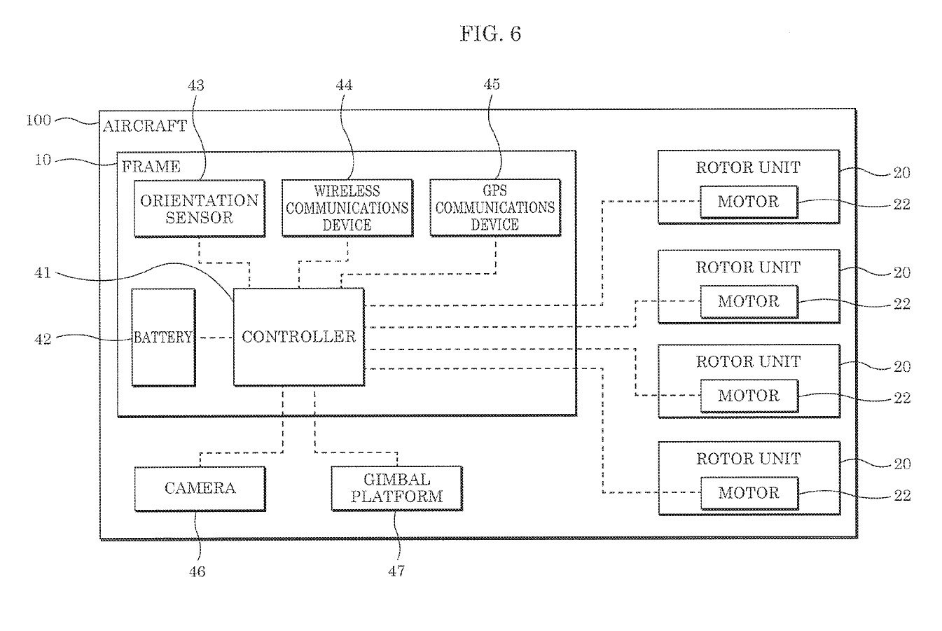

Frame 10 of aircraft 100 and components on-board frame 10 will be described with reference to FIG. 1 through FIG. 3 and FIG. 6. FIG. 6 is a block diagram illustrating components included in aircraft 100 according to Embodiment 1.

As illustrated in FIG. 1 through FIG. 3 and FIG. 6, frame 10 includes frame main body 11 and four hollow rod-shaped arms 12 that extend radially from lateral wall 11a of frame main body 11. The components in frame 10 including frame main body 11 and arms 12 may be made from any type of material. Frame main body 11 is internally equipped with controller 41, battery 42, and orientation sensor 43. Furthermore, wireless communications device 44 and global positioning system (GPS) communications device 45 are provided on end wall 11b of frame main body 11. Gimbal platform 47 of camera 46 is attached to the outer surface of end wall 11c of frame main body 11. End walls 11b and 11c are the two circular plate-shaped end walls that close both ends of cylindrical lateral wall 11a of frame main body 11. Aircraft 100 normally flies with end wall 11b on the top and end wall 11c on the bottom.

Battery 42 is a rechargeable secondary battery, and a power source for aircraft 100. Battery 42 may be any secondary battery, such as a lithium-ion battery, a sodium-ion battery, a nickel-metal hydride battery, a nickel-cadmium battery, or capacitor. Any battery such as a dry-cell battery or primary battery may be used in place of battery 42 as a power source for aircraft 100.

Orientation sensor 43 detects the orientation of frame 10, that is, the orientation of aircraft 100. Orientation sensor 43 includes, for example, an angular acceleration sensor and a three-axis gyrosensor (also referred to as a three-axis angular speed sensor). Based on, for example, the three-axis acceleration and three-axis angular speed detected by orientation sensor 43, controller 41 detects, for example, the orientation, direction of travel, and velocity of frame 10, that is to say, aircraft 100.

GPS communications device 45 detects positional information including a planimetric position and elevation of aircraft 100 by using radio waves received from a satellite. Note that a planimetric position is a position at sea level on the earth. GPS communications device 45 transmits the detected positional information in real time to controller 41. GPS communications device 45 may be configured to wirelessly communicate with steering controller 101 via satellite-based communication

Wireless communications device 44 wirelessly communicates with steering controller 101. Wireless communications device 44 may be a communications circuit including a communications interface. Moreover, in addition to the function for communicating with steering controller 101, wireless communications device 44 may also include a function for communicating via a mobile communications protocol used by mobile communications systems such as the third-generation mobile communications system (3G), fourth-generation mobile communications system (4G), or LTE (registered trademark). In such cases, wireless communications device 44 may communicate with a communications terminal of, for example, the operator of aircraft 100. The communications terminal may be, for example, a mobile phone, smartphone, smart watch, tablet, or compact personal computer.

For example, a digital camera or digital video camera that records captured images as digital data can be used as camera 46. Gimbal platform 47 allows for the orientation of camera 46 to be changed freely and supports camera 46. Gimbal platform 47 may be configured such that the movable part is driven by an electric drive device such as a motor or actuator.

Moreover, frame 10 may also be equipped with various other devices such as a lamp, a light-emitting device including, for example, a light-emitting diode (LED), a projector, a speaker, a microphone, and/or any sort of gauge. The lamp can be used to illuminate the area around aircraft 100. The light-emitting device can be used to indicate the position of aircraft 100 to its surroundings at night or in a dark location, for example. The projector can project an image on the inflated balloon 30 when, for example, balloon 30 is made of a semi-transparent or transparent material. The speaker emits sound, including speech, to the surroundings of aircraft 100. The microphone can pick up sound from the surroundings of aircraft 100.

Controller 41 is for controlling the respective components included in aircraft 100. How controller 41 is implemented is not limited so long as it includes a control function. For example, controller 41 may be implemented as dedicated hardware such as an electronic control unit including, for example, a circuit including a microcomputer. Moreover, for example, controller 41 may be implemented by executing a software program appropriate far each component. In such cases, controller 41 may include an arithmetic processing unit (not illustrated in the drawings) and a storage (not illustrated in the drawings) that stores a control program. Examples of the arithmetic processing unit include a micro processing unit (MPU) and a central processing unit (CPU). Examples of the storage include memory. Controller 41 may be implemented as a single controller that performs centralized control, and may be implemented as a plurality of controllers for performing decentralized control in cooperation with each other.

Controller 41 is configured to control the devices equipped in aircraft 100, including motors 22 of rotor units 20, battery orientation sensor 43, wireless communications device 44, and GPS communications device 45. Furthermore, controller 41 may be configured to control camera 46 equipped on gimbal platform 47.

Controller 41 controls the supply of power to each electrical component of aircraft 100 that uses power from battery 42. Controller 41 also controls the charging of battery 42 using power from a power source external relative to aircraft 100, such as a power grid. Controller 41 may include a converter that controls the charging of battery 42, and may include an inverter that controls the discharging of battery 42.

Furthermore, based on the information obtained by orientation sensor 43, controller 41 detects, for example, the orientation, direction of travel, and velocity of aircraft 100. Based on the detected orientation, direction of travel, and velocity, etc., of aircraft 100, controller 41 controls the operation of motors 22 in the four rotor units 20 such that the operation of aircraft 100 follows command signals received from steering controller 101. Power and communications line 50 (see FIG. 3) that connects controller 41, etc., to motor 22 in each rotor unit 20 is routed through hollow arms 12 of frame 10.

Controller 41 transmits, via wireless communication using wireless communications device 44 or via satellite-based communication using GPS communications device 45, positional information including the planimetric position and elevation of aircraft 100 received in real time from GPS communications device 45, to steering controller 101 in real time or at an appropriate timing. Steering controller 101 may be configured to be capable of satellite-based communication in addition to wireless communication using wireless communications device 44. Moreover, controller 41 may transmit positional information on aircraft 100 to a communications terminal of, for example, the operator of aircraft 100.

Steering controller 101 is configured to be able to receive an input for a flying destination for aircraft 100, and transmits positional information including the planimetric position and elevation of the input flying destination to controller 41 of aircraft 100. Based on the received flying destination positional information and the real time positional information of aircraft 100, controller 41 can implement control for causing aircraft 100 to autonomously fly to the flying destination.

Moreover, when connected to camera 46, controller 41 controls operation of camera 46. Furthermore, when the movable parts of gimbal platform 47 are driven by an electric drive device, controller 41 may control operation of gimbal platform 47 by controlling the electric drive device. Here, controller 41 may control operation of camera 46 and gimbal platform 47 in accordance with commands received from steering controller 101 that relate to operation of camera 46 and operation of gimbal platform 47.

Each arm 12 of frame 10 is configured so as to be separable into two parts in the axial direction, that is, the lengthwise direction. More specifically, each arm 12 is separable into hollow, rod-shaped first arm part 12a that is integral with frame main body 11 of frame 10, and hollow, rod-shaped second arm part 12b that is integral with rotor frame 23 of rotor unit 20. First arm part 12a and second arm part 12b are coaxially aligned and coupled together at end section 12aa of first arm part 12a and end section 12ba of second arm part 12b (see FIG. 3). Coupling part 13 (see FIG. 3) constituting the connecting part of end section 12aa of first arm part 12a and end section 12ba of second arm part 12b is configured such that first arm part 12a and second arm part 12b can be freely coupled and separated.

As illustrated in FIG. 2 and FIG. 3, coupling part 13 is located inside balloon 30. More specifically, the boundary between end section 12aa and end section 12ba in coupling part 13 is located inside balloon 30. Accordingly, the entire second arm part 12b is located inside lateral through-hole 30e formed in balloon 30, that is to say, located inside balloon 30. Note that lateral through-hole 30e is a through-hole in balloon 30 that extends from through-hole 30a in a direction substantially perpendicular to the axis of through-hole 30a. In this embodiment, lateral through-hole 30e opens at one of the four corners formed by the four lateral surfaces 30f, 30g, 30h, and 30i between surfaces 30c and 30d of balloon 30. Note that the location of coupling part 13 is not limited to the above example. For example, each arm 12 may be configured so as not to be separable into first arm part 12a and second arm part 12b, but rather such that coupling part 13 is arranged in a position at which arm 12 directly connects to rotor frame 23 of rotor unit 20.

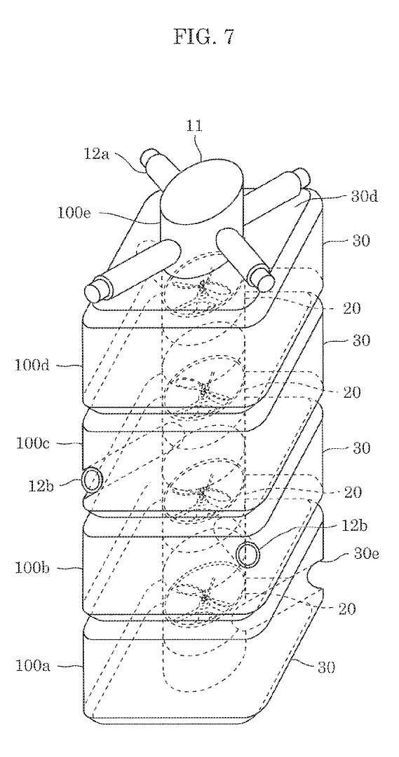

As illustrated in FIG. 2 and FIG. 7, aircraft 100 as described above is constituted of five units 100a, 100b, 100c, 100d, and 100e. Units 100a, 100b, 100c, and 100d can be freely coupled to and separated from unit 100e and vice versa via coupling part 13. FIG. 7 is a perspective view illustrating the five separable units 100a, 100b, 100c, 100d, and 100e that constitute aircraft 100 illustrated in FIG. 1 in a state in which they are stacked one on top of another.

In FIG. 7, units 100a, 100b, 100c, 100d, and 100e are stacked in the listed order from the bottom up.

Unit 100a includes one rotor unit 20, and balloon 30 and second arm part 12b corresponding to that rotor unit 20. Second arm part 12b in unit 100a corresponds to, among the four arms 12, arm 121 illustrated in FIG. 2

Unit 100b includes one rotor unit 20, and balloon 30 and second arm part 12b corresponding to that rotor unit 20. Second arm part 12b in unit 100b corresponds to, among the four arms 12, arm 122 illustrated in FIG. 2

Unit 100c includes one rotor unit 20, and balloon 30 and second arm part 12b corresponding to that rotor unit 20. Second arm part 12b in unit 100c corresponds to, among the four arms 12, arm 123 illustrated in FIG. 2.

Unit 100d includes one rotor unit 20, and balloon 30 and second arm part 12b corresponding to that rotor unit 20. Second arm part 12b in unit 100d corresponds to, among the four arms 12, arm 124 illustrated in FIG. 2. Unit 100e includes frame main body 11 of frame 10 and the four first arm parts 12a. Here, units 100a, 100b, 100c, and 100d are each an example of the first unit, and unit 100e is an example of the second unit.

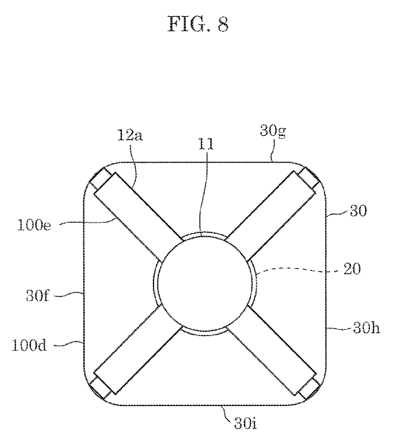

As illustrated in FIG. 7 and FIG. 8, in this embodiment, in each of units 100a, 100b, 100c, and 100d, second arm part 12b does not protrude from balloon 30. Accordingly, the contour of each of units 100a, 100b, 100c, and 100d matches the contour of the respective balloon 30. FIG. 8 is a plan view of the five units 100a, 100b, 100c, 100d, and 100e when stacked as shown in FIG. 7 from above, that is to say, a plan view from the perspective of unit 100e looking toward unit 100a.

Unit 100e has a shape and a size to fit within the contour of balloon 30 when unit 100e is placed on surface 30c or 30d of balloon 30. In other words, when unit 100e is viewed while it is placed on surface 30c or 30d, the four first arm parts 12a of unit 100e can fit within the contour of balloon 30 defined by lateral surfaces 30f, 30g, 30h, and 30i. More specifically, in this embodiment, when unit 100e is placed on surface 30c or 30d such that each of the four first arm parts 12a are positioned at a different one of the four corners of balloon 30 formed by lateral surfaces 30f, 30g, 30h, and 30i, unit 100e fits within the contour of balloon 30.

Accordingly, all units 100a, 100b, 100c, 100d, and 100e can be placed and stacked in a column on surface 30c or 30d of balloon 30 so as to fit within the contour of one balloon 30 when viewed in a direction from surface 30c to surface 30d. With this, when transporting or storing units 100a, 100b, 100c, 100d, and 100e, the surface area that units 100a, 100b, 100c, 100d, and 100e occupy can be reduced. This moreover makes it possible to reduce the size of the case for housing units 100a, 100b, 100c, 100d, and 100e.

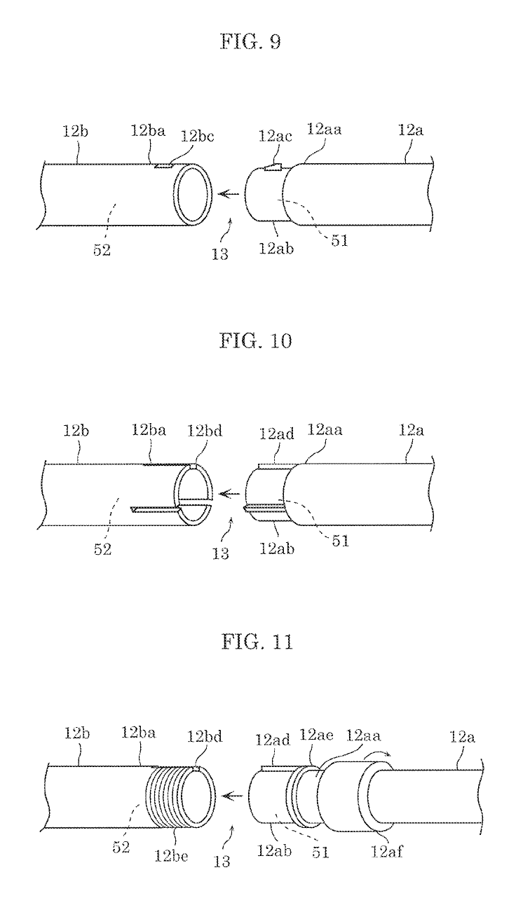

Next, the configuration of coupling part 13 of first arm part 12a and second arm part 12b will be further described in detail with reference to FIG. 3 and FIG. 9. FIG. 9 is an enlarged perspective view of coupling part 13 of first arm part 12a and second arm part 12b illustrated in FIG. 3. In this embodiment, coupling part 13 is configured such that end section 12aa of cylindrical first arm part 12a fits inside end section 12ba of cylindrical second arm part 12b. Coupling part 13 further includes first connector 51 and second connector 52. First connector 51 is embedded in end section 12aa of first arm part 12a, and second connector 52 is embedded in end section 12ba of second arm part 12b. First connector 51 is connected to power and communications line 50 extending from controller 41, etc., through first arm part 12a. Second connector 52 is connected to power and communications line 50 extending from motor 22 of rotor unit 20 through second arm part 12b. When first connector 51 and second connector 52 are physically connected together, power and communications lines 50 respectively connected to first connector 51 and second connector 52 are electrically connected together. Moreover, when end section 12aa of first arm part 12a is fitted in end section 12ba of second arm part 12b, first connector 51 and second connector 52 are physically connected together.

As illustrated in FIG. 9, coupling part 13 includes a snap-fit structure for first arm part 12a and second arm part 12b. A cylindrical fitting 12ab having a reduced diameter resulting from a step is formed on the distal end region of end section 12aa of first arm part 12a. Fitting 12ab has an outer circumferential surface that matches the inner circumferential surface of end section 12ba of second arm part 12b. Furthermore, a single locking protrusion 12ac is provided protruding from the cylindrical outer circumferential surface of fitting 12ab. Locking protrusion 12ac is provided so as to protrude from and retract into the outer circumferential surface of fitting 12ab, Although not illustrated in the drawings, locking protrusion 12ac protrudes as a result of receiving an elastic force exerted by an elastic component. For example, locking protrusion 12ac has a wedge shape that slopes downward toward the distal end of fitting 12ab, which is the open end of fitting 12ab.

A single locking hole 12bc is formed through the cylindrical surrounding wall of end section 12ba of second arm part 12b. Locking hole 12bc has a shape and a size to allow locking protrusion 12ac to fit therein. Locking hole 12bc is disposed so as to be positioned at locking protrusion 12ac when fitting 12ab of first arm part 12a is inserted in end section 12ba of second arm part 12b and the step at the base of fitting 12ab abuts end section 12ba.

Upon connecting via coupling part 13, fitting 12ab of first arm part 12a is inserted into end section 12ba of second arm part 12b and locking protrusion 12ac is pushed down by the surrounding wall of end section 12ba. Furthermore, when the step at the base of fitting 12ab abuts end section 12ba, locking protrusion 12ac protrudes through and fits in locking hole 12bc. In other words, locking protrusion 12ac snap-fits with locking hole 12bc. As a result, first arm part 12a and second arm part 12b are coupled by being fixed in the coupling direction, which is the fitting direction of fitting 12ab, as well as in the twisting direction, which is the outer circumferential direction of fitting 12ab. With the above coupling procedure, first connector 51 and second connector 52 are physically and electrically connected together.

By fitting the respective locking protrusions 12ac and locking holes 12bc together, units 100a, 100b, 100c, 100d are not only fixed in the coupling direction and twisting direction relative to unit 100e, but are also positioned in place in the lengthwise direction coupling direction) of arms 12 and the outer circumferential direction (i.e., twisting direction) of arms 12. When units 100a, 100b, 100c, and 100d are positioned in place, the axes of rotation of propellers 21 of each rotor unit 20 in units 100a, 100b, 100c, and 100d are substantially parallel to one another and substantially parallel to the axis of cylindrical lateral wall 11a of frame main body 11 of frame 10.

Moreover, by pressing down locking protrusion 12ac fitted in locking hole 12bc and pulling first arm part 12a and second arm part 12b apart from each other, first arm part 12a and second arm part 12b are uncoupled. At the same time, first connector 51 and second connector 52 are disconnected. Accordingly, the connection achieved by coupling part 13 is undone. Note that fitting 12ab and locking protrusion 12ac of first arm part 12a may be disposed on second arm part 12b, and locking hole 12bc of second arm part 12b may be disposed on first arm part 12a.

As illustrated in FIG. 2 and FIG. 9 and described above, the four rotor units 20 include first rotor units 201 and second rotor units 202 respectively including first propellers 211 and second propellers 212, which have different structures. As a result, units 100a, 100b, 100c, and 100d are each assembled to their corresponding one of the four arms 12, that is, arms 121, 122, 123, and 124. In order to simplify assembly, the positions of locking protrusions 12ac and locking holes 12bc may be mutually offset in the outer circumferential direction on first arm parts 12a and second, arm parts 12b among units 100a, 100b, 100c, and 100d. Alternatively, the shape and/or the size of locking protrusions 12ac and locking holes 12bc may be mutually different. Accordingly, if first arm parts 12a and second arm parts 12b are coupled in a state in which arm 121, 122, 123, or 124 and unit 100a, 100b, 100c, or 100d are incompatible, aircraft 100 may be in an abnormal state. Examples of an “abnormal state” include a state in which locking protrusion 12ac does not fit in locking hole 12bc, a state in which locking protrusion 12ac fits in locking hole 12bc but there is a large amount of play in coupling part 13, and a state in which propeller 21 of rotor unit 20 is not oriented in its predetermined orientation after being fitted. As a result, it is easy to tell if the parts correctly correspond or not.

Moreover, first part 12a may include a plurality of locking protrusions 12ac, and second arm part 12b may include a plurality of locking holes 12bc. Furthermore, the shape, size, number, position, and/or pitch of locking protrusions 12ac and locking holes 12bc may be different among units 100a, 100b, 100c, and 100d. As a result, assembly of arms 121, 122, 123, and 124 to their respective units 100a, 100b, 100c, and 100d is easier.

Moreover, coupling part 13 may have the configuration illustrated in FIG. 10. FIG. 10 is a perspective view of another example of coupling part 13 of first arm part 12a and second arm part 12b illustrated in FIG. 3, illustrated in the same manner as FIG. 9. As illustrated in FIG. 10, coupling part 13 includes a fitting structure including strip-shaped protrusions 12ad on first arm part 12a and slits 12bd in second arm part 12b. One or more strip-shaped protrusion 12ad is formed protruding from the outer circumferential surface of fitting 12ab of first arm part 12a. Strip-shaped protrusion 12ad is an elongated rib that extends lengthwise along the axis of fitting 12ab. In the example illustrated in FIG. 10, three strip-shaped protrusions 12ad are arranged spaced apart from each other in the outer circumferential direction of fitting 12ab. Elongated slits 12bd are formed through the surrounding wall of end section 12ba of second arm part 12b. The same number of slits 12bd and strip-shaped protrusions 12ad are provided. Slits 12bd extend lengthwise along the lengthwise direction of second arm part 12b. Slits 12bd are disposed in positions that correspond with strip-shaped protrusions 12ad when first arm part 12a and second arm part 12b are coupled, and have a shape and a size to fit with the corresponding strip-shaped protrusions 12ad.

When connecting via coupling part 13, fitting 12ab of first arm part 12a is inserted into end section 12ba of second arm part 12b so that strip-shaped protrusions 12ad are inserted in and fit with slits lad, and pushed until the step at the base of fitting 12ab abuts end section 12ba. As a result, first arm part 12a and second arm part 12b are mutually fixed in the outer circumferential direction of fitting 12ab due to strip-shaped protrusions 12ad fitting in slits 12bd. Furthermore, due to friction between fitting 12ab, strip-shaped protrusions 12ad, and the surrounding wall of end section 12ba of second arm part 12b, first arm part 12a and second arm part 12b are mutually fixed in the fitting direction of fitting 12ab. Note that a component for reinforcing the fixing of first arm part 12a and second arm part 12b in the fitting direction may be provided. With the coupling described above, the surface area of the engagement between strip-shaped protrusions 12ad and end section 12ba of second arm part 12b is greater than the surface area of engagement between locking protrusion 12ac and end section 12ba illustrated in FIG. 9. Accordingly, torsional rigidity is increased. Moreover, the connection achieved by coupling part 13 can be undone by pulling first arm part 12a and second arm part 12b apart.

The shape, size, number, position and/or pitch between strip-shaped protrusions 12ad and slits 12bd may differ between the four arms 121, 122, 123, and 124. Moreover, strip-shaped protrusions 12ad and slits 12bd may be provided in combination with locking protrusion 12ac and locking hole 12bc.

Coupling part 13 may have the configuration illustrated in FIG. 11. FIG. 11 is a perspective view of yet another example of coupling part 13 of first arm part 12a and second arm part 12b illustrated in FIG. 3, illustrated in the same manner as FIG. 9. As illustrated in FIG. 11, coupling part 13 includes a structure employing threaded fastening to fix first arm part 12a and second arm part 12b in the fitting direction of fitting 12ab in FIG. 10.

At the base of fitting 12ab of first arm part 12a, a ring-shaped locking brim 12ae protrudes radially from the outer circumferential surface of fitting 12ab and surrounds the outer circumferential surface of fitting 12ab. Locking brim 12ae protrudes more radially outward than end section 12aa of first arm 2part 12a. Furthermore, on the outer circumferential surface of fitting 12ab, single strip-shaped protrusion 12ad extends from locking brim 12ae to the open end of fitting 12ab, in a similar manner as the example illustrated in FIG. 10. Still furthermore, first arm part 12a includes fastener 12af having the shape of a cylinder with a bottom, similar to a cap nut. The base of fastener 12af through which first arm part 12a passes is located on the opposite side of locking brim 12ae relative to fitting 12ab, and the cylindrical portion of fastener 12af surrounds end section 12aa and extends from the base of fastener 12af toward the open end of fitting 12ab. Moreover, female threads are formed on the inner circumferential surface of the cylindrical portion of fastener 12af. A single slit 12bd is formed on end section 12ba of second arm part 12b, in a similar manner as illustrated in FIG. 10. Furthermore, male threads 12be that can screw together with the female threads on fastener 12af are formed on the outer circumferential surface of end section 12ba.

When connecting via coupling part 13, fitting 12ab of first arm part 12a is inserted into end section 12ba of second arm part 12b such that strip-shaped protrusion 12ad is inserted in and fits with slit 12bd, and pushed until locking brim 12ae abuts end section 12ba. Furthermore, the female threads of fastener 12af are screwed together with male threads 12be by rotating fastener 12af in the fastening direction. With this, the base of fastener 12af and the end section 12ba of second arm part 12b are pulled toward each other so as to sandwich locking brim 12ae. As a result, second arm part 12b is fixed to locking brim 12ae, that is to say, first arm part 12a, in the insertion direction of fitting 12ab. Since second arm part 12b is fastened to first arm part 12a via threaded coupling, strength in the separating direction of coupling part 13 is increased. Furthermore, first arm part 12a and second arm part 12b are mutually fixed in the outer circumferential direction of fitting 12ab due to strip-shaped protrusion laid fitting in slit 12bd. Moreover, the connection achieved by coupling part 13 can be undone by loosening the threaded coupling via fastener 12af.

The shape, size, number, position and/or pitch between strip-shaped protrusion 12ad and slit 12bd may differ between the four arms 121, 122, 123, and 124. Moreover, strip-shaped protrusion 12ad, slit 12bd, locking brim 12ae, and fastener 12af may be provided in combination with locking protrusion 12ac and locking hole 12bc. Moreover, strip-shaped protrusion 12ad and slit 12bd may be omitted from coupling part 13 illustrated in FIG. 11. In such cases, due to friction from the threaded coupling and fastening of fastener 12af, first arm part 12a and second arm part 12b can be fixed together in the fitting direction and outer circumferential direction of fitting 12ab.

Note that the configuration of coupling part 13 is not limited to the above examples; various configurations may be used. For example, by press fitting 12ab of first arm part 12a into end section 12ba of second arm part 12b, first arm part 12a and second arm part 12b may be fixed and coupled together by the friction therebetween. Alternatively, by screwing fitting 12ab of first arm part 12a having male threads on the outer circumferential surface together with end section 12ba of second arm part 12b having female threads on the inner circumferential surface, first arm part 12a and second arm part 12b may be fixed and coupled together. Alternatively, in coupling part 13 configured as illustrated in FIG. 11, locking brim 12ae may be omitted from first arm part 12a, and a bite type fitting structure may be implemented. More specifically, a cylindrical collar is inserted between the tapered inner circumferential surface in the vicinity of the open end of end section 12ba of second arm part 12b and the outer circumferential surface of fitting 12ab of first arm part 12a, Note that the tapered inner circumferential surface of end section 12ba increases in diameter with decreasing distance to the open end. By twisting, in the fastening direction, fastener 12af whose female threads are engaged with male threads 12be of end section 12ba, the surrounding wall of end section 12ba having the tapered inner circumferential surface presses the collar against fitting 12ab so as to bite into fitting 12ab. This couples and fixes first arm part 12a and second arm part 12b together.

Alternatively, for example, the configuration of coupling part 13 need not have a configuration in which fitting 12ab of first arm part 12a is inserted into end section 12ba of second arm part 12b, but may have a configuration in which end section 12aa of first arm part 12a and end section 12ba of second arm part 12b abut face to face. In such cases, a separate component for fixing end section 12aa and end section 12ba together may be provided. Moreover, at the abutting region, end section 12aa and end section 12ba may fit together,

### (1-2. Advantageous Effects, Etc.)

As described above, aircraft 100 according to the present disclosure includes: a plurality of rotor units 20 each including propeller 21 and motor 22 that drives propeller 21; a plurality of balloons 30 as shock absorbers provided to the plurality of rotor units 20; and frame 10 to which the plurality of rotor units 20 attach. The plurality of rotor units 20 and the plurality of balloons 30 are attachable to and detachable from frame 10.

With the above-described configuration, since the plurality of rotor units 20 of aircraft 100 have the plurality of balloons 30 as shock absorbers, when, for example, aircraft 100 contacts an object mid-flight, the plurality of balloons 30 can reduce the impact and damage imparted to the plurality of rotor units 20. This improves the flight stability of aircraft 100. Furthermore, when, for example, transporting or storing aircraft 100, the plurality of balloons 30 and the plurality of rotor units 20 can be separated from frame 10 of aircraft 100. This makes it possible to reduce the space occupied by the components included in aircraft 100. In other words, this improves the transportability of aircraft 100.

With aircraft 100 according to the present disclosure, balloons 30 filled with gas are used as shock absorbers. With the above-described configuration, balloons 30 filled with gas can reduce the effect of an impact by deforming when, for example, aircraft 100 contacts an external object. Moreover, since balloons 30 filled with gas are light in weight, this contributes to an overall reduction in weight of aircraft 100. Furthermore, when the specific gravity of the gas filling balloons 30 is less than that of the atmosphere, balloons 30 make aircraft 100 buoyant. This makes it possible to reduce the energy consumed by rotor units 20 when aircraft 100 is flying.

In aircraft 100 according to the present disclosure, balloon 30 laterally covers rotor unit 20, across a height of rotor unit 20 in an up-and-down direction. With the above-described configuration, when aircraft 100 contacts an object mid-flight, balloons 30 that laterally cover rotor units 20 across the height of rotor units 20 in the up-and-down direction contact the object, effectively inhibiting contact between rotor units 20 and the object. Moreover, balloons 30 inhibit damage to an external object or person and propellers 21 resulting from the external object or person touching propellers 21 from the lateral side of rotor units 20.

Aircraft 100 according to the present disclosure includes: units 100a, 100b, 100c, and 100d each including rotor unit 20 and balloon 30 provided to rotor unit 20; unit 100e including frame 10; and a plurality of coupling parts 13 that respectively connect units 100a, 100b, 100c, and 100d to unit 100e. With the above-described configuration, units 100a, 100b, 100c, and 100d are each a combination of one rotor unit 20 and one balloon 30 and handled as a single unit, and unit 100e includes frame 10 and is handled as a single unit. The units are connected and disconnected together via coupling parts 13. Accordingly, since the number of components handled, that is to say, the number of units, can be reduced, assembly and disassembly of units 100a through 100e is easy.

In aircraft 100 according to the present disclosure, each coupling part 13 is positioned inside a balloon 30. With the above-described configuration, coupling parts 13 can be inhibited from protruding from balloons 30 in units 100a, 100b, 100c, and 100d. With this, the external shape of each unit 100a, 100b, 100c, and 100d is essentially defined by rotor unit 20 and balloon 30. This makes it possible to reduce the space occupied by units 100a, 100b, 100c, and 100d.

In aircraft 100 according to the present disclosure, an area that unit 100e occupies in a plan view when separated from units 100a, 100b, 100c, and 100d has a shape and a size that fit within an area that each of units 100a, 100b, 100c, and 100d occupies in a plan view when separated from unit 100e. With the above-described configuration, when units 100a, 100b, 100c, and 100d, as well as unit 100e are stacked in a single column, unit 100e can be arranged so as to not protrude beyond the lateral sides of units 100a, 100b, 100c, and 100d. This makes it possible to reduce the space occupied by units 100a, 100b, 100c, 100d, and 100e when stacked.

In aircraft 100 according to the present disclosure, units 100a, 100b, 100c, and 100d have approximately the same external shape and approximately the same external size. With the above-described configuration, units 100a, 100b, 100c, and 100d can be stacked while arranged in a single column, thereby reducing the space they occupy.

In aircraft 100 according to the present disclosure, units 100a, 100b, 100c, a and 100d are physically and electrically connected to unit 100e by coupling parts 13. With the above-described configuration, physical and electrical connection can be achieved via the coupling action using coupling part 13, thereby simplifying the connecting process.

### Embodiment 2

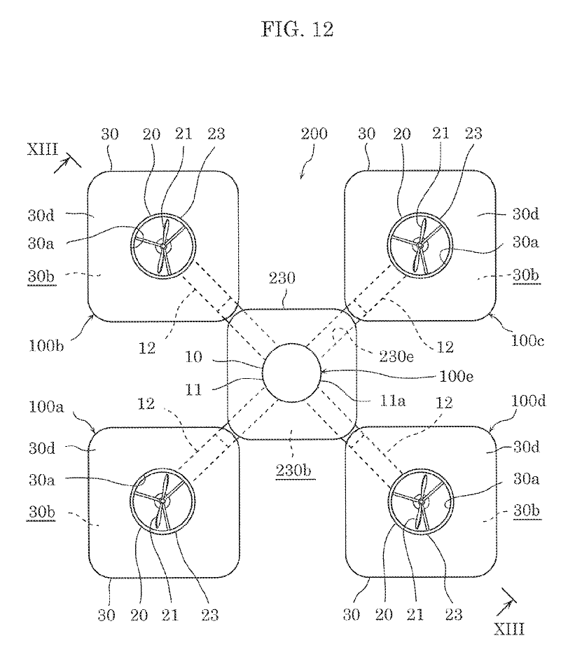

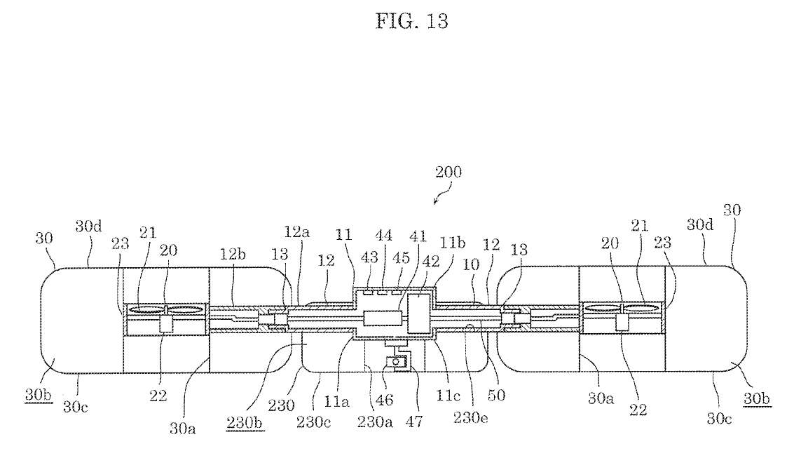

Next, aircraft 200 according to Embodiment 2 will be described with reference to FIG. 12 and FIG. 13. FIG. 12 is a plan view of aircraft 200 according to Embodiment 2, similar to the view of FIG. 2. FIG. 13 is a cross-sectional side view of aircraft 200, taken at line XIII-XIII illustrated in FIG. 12. In the following description of the embodiment, elements that have the same reference numerals as in FIG. 1 through FIG. 11 indicate the same or similar elements, and as such, detailed description thereof is omitted. Furthermore, points that are similar to the embodiment described above are omitted.

As illustrated in FIG. 12 and FIG. 13, aircraft 200 includes, in addition to the configuration of aircraft 100 according to Embodiment 1, second balloon 230, which is a shock absorber mainly for frame main body 11 of frame 10. Second balloon 230 is made of the same material as balloons 30, which are first balloons. A single second balloon 230 is shaped so as to circumvent the four arms 12 and is attached so as to surround lateral wall 11a and end wall 11c of frame main body 11 from the outside. Second balloon 230 is disposed in the middle of the four first balloons 30. When inflated, the external shape of second balloon 230 is a flattened cuboid, just like first balloons 30. The contour of second balloon 230 when viewed in a direction from end wall 11b to end wall 11c of frame main body 11 has a shape and a size to fit within the contour of balloon 30 when viewed in a direction from surface 30d to surface 30c.

A cylindrical hole 230a extending from end wall 11c of frame main body 11 is formed in second balloon 230. Hole 230a extends away from end wall 11e along the axis of cylindrical lateral wall 11a of frame main body 11, and the distal end of hole 230a is open. In this embodiment, the inner diameter of hole 230a is smaller than the diameter of end wall 11e, allowing second balloon 230 to partially cover end wall 11c. However, the inner diameter of hole 230a may be approximately the same diameter as end wall 11c. Hole 230a has a shape and a size to allow for camera 46 and gimbal platform 47 to be disposed therein. The axis of hole 230a of second balloon 230 is aligned with the axes of through-holes 30a of first balloons 30.

Second balloon 230 has a single, continuous chamber 230b that is formed on the inner side of the sheet material and circumferentially surrounds lateral wall 11a of frame main body 11 and hole 230a. In this embodiment, second balloon 230 is disposed such that surface 230c at which hole 230a in second balloon 230 opens is flush with surfaces 30c of first balloons 30. This gives second balloon 230 a shock absorbing function in the axial direction of through-hole 30a and hole 230a, just like first balloons 30. The four arms 12 of frame 10 each pass through four respective lateral holes 230e in second balloon 230 and extend out of second balloon 230. The four lateral holes 230e are formed extending radially through second balloon 230, from the lateral sides of frame main body 11.

Moreover, in this embodiment, unit 100e includes second balloon 230, frame main body 11, and first arm parts 12a of arms 19. When units 100a, 100b, 100c, 100d, and 100e are stacked in a column, unit 100e can be arranged so as to not protrude beyond the lateral sides of units 100a, 100b, 100c, and 100d.

Moreover, other components and operations of aircraft 200 according to Embodiment 2 are the same as described in Embodiment 1, and as such, description thereof is omitted. Furthermore, aircraft 200 according to Embodiment 2 achieves the same advantageous effects as aircraft 100 according to Embodiment 1. Still furthermore, aircraft 200 according to Embodiment 2 includes second balloon 230 provided to frame 10. With the above-described configuration, since second balloon 230 is provided to frame 10 in addition to first balloons 30 provided to rotor units 90, the buoyancy of aircraft 100 provided by balloons 30 and 230 increases. Furthermore, balloons 30 and 230 make it possible to provide a shock absorbing function to frame 10 in addition to rotor units 20.

Note that with aircraft 200 according to Embodiment 2, there is a gap between balloons 30 and 230 which exposes part of arms 12 of frame 10, but balloons 30 and 230 may contact one another to provide complete coverage so as to not expose arms 12. In such cases, when aircraft 200 contacts an object or person, for example, since a shock absorbing function is provided to arms 12 in addition to rotor units 20 and frame main body 11 of frame 10 in aircraft 200, it is possible to reduce damage to both aircraft 200 and the object or person contacted.

### Embodiment 3

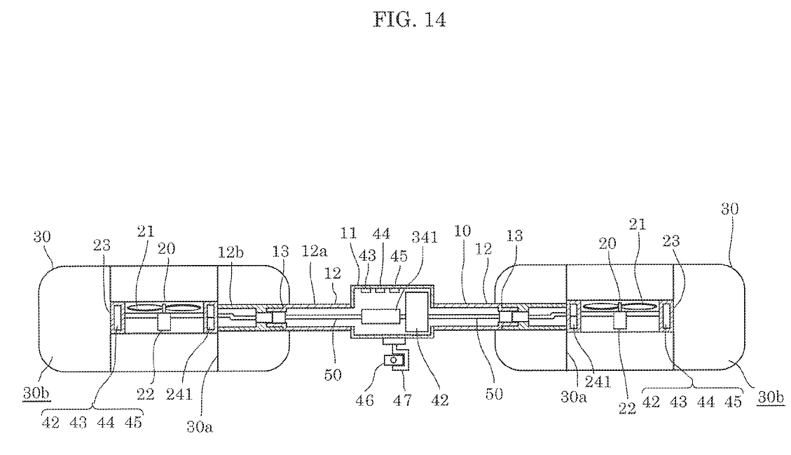

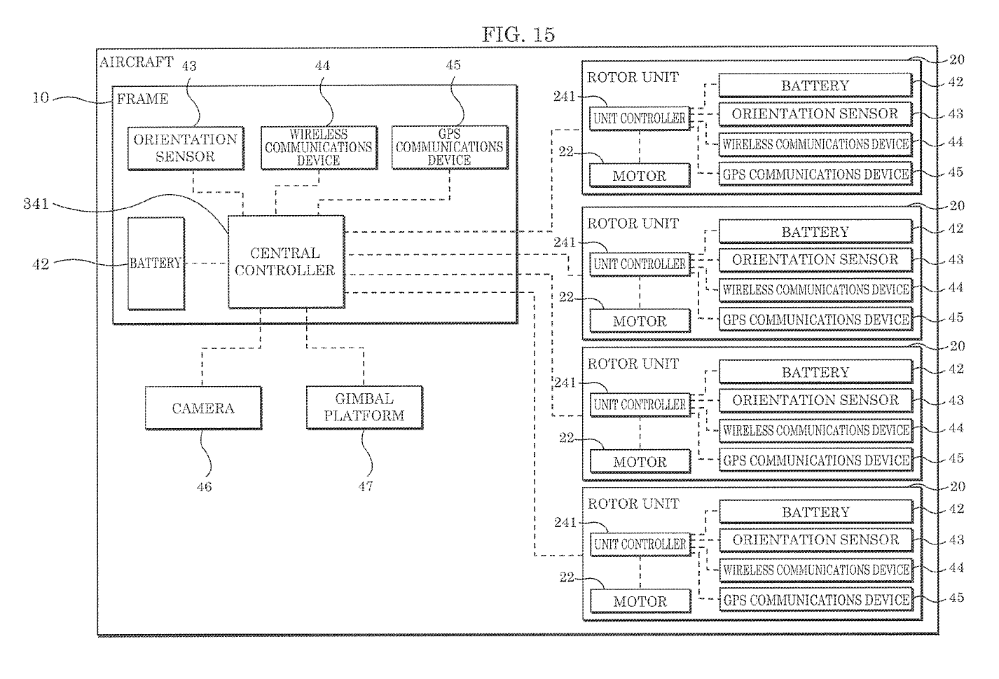

Next, an aircraft according to Embodiment 3 will be described with reference to FIG. 2, FIG. 14, and FIG. 15. FIG. 14 is a cross sectional side view of an aircraft according to Embodiment 3, similar to the view of FIG. 3. FIG. 15 is a block diagram illustrating components included in aircraft 100 according to Embodiment 3.

As illustrated in FIG. 2, FIG. 14, and FIG. 15, in the aircraft according to Embodiment 3, units 100a, 100b, 100c, and 100d are each configured to be able to communicate wirelessly with steering controller 101 and fly individually in a state in which they are separated from unit 100e. Rotor frame 23 of rotor unit 20 in each unit 100a, 100b, 100c, and 100d has a hollow structure. Each rotor unit 20 includes, in or on rotor frame 23, unit controller 241, battery 42, orientation sensor 43, and wireless communications device 44. Each rotor unit 20 may further include, on rotor frame 23, GPS communications device 45. Still furthermore, rotor frame 23 of each rotor unit 20 may be configured such that gimbal platform 47 of camera 46 can be attached thereto.

Similar to controller 41 of aircraft 100 according to Embodiment 1, each unit controller 241 wirelessly communicates with steering controller 101 and controls components such as motor 22 of rotor unit 20, and as a result, controls the flying of respective units 100a, 100b, 100c, and 100d.

Moreover, in place of controller 41, central controller 341 is provided to frame main body 11 of frame 10. When units 100a, 100b, 100c, and 100d are connected to unit 100e, central controller 341 is configured to control unit controllers 241 included in the respective units 100a, 100b, 100c, and 100d. By using, for example, orientation sensor 43, wireless communications device 44, and GPS communications device 45 on frame main body 11, central controller 341 wirelessly communicates with steering controller 101, controls unit controllers 241 included in the respective units 100a, 100b, 100c, and 100d, and cooperatively drives motors 22 in the four rotor units 20. With this, central controller 341 controls flight of the aircraft including units 100a, 100b, 100c, 100d, and 100e. Note that central controller 341 may be configured to also control flight of the aircraft in a state in which at least one of units 100a, 100b, 100c, and 100d is connected to unit 100e.

Central controller 341 may fly the aircraft using only power from battery 42 in frame main body 11, may fly the aircraft using only power from batteries 42 in rotor units 20, and may fly the aircraft using both power from battery 42 in frame main body 11 and power from batteries 42 in rotor units 20. When using only power from batteries 42 in rotor units 20, frame main body 11 need not include battery 42. This makes it possible to reduce the weight of the aircraft. On the other hand, using power from battery 42 in frame main body 11 makes it possible to increase the duration of flight of the aircraft.

Central controller 341 may control flight of the aircraft by selectively using or using all of orientation sensors 43, wireless communications devices 44, and GPS communications devices 45 in rotor units 20, without the use of orientation sensor 43, wireless communications device 44, and GPS communications device 45 included in frame main body 11. In such cases, frame main body 11 need not include orientation sensor 43, wireless communications device 44, or GPS communications device 45. Alternatively, central controller 341 may control flight of the aircraft by using a selected combination of: orientation sensors 43, wireless communications devices 44, and GPS communications devices 45 in rotor units 20 and orientation sensor 43, wireless communications device 44, and GPS communications device 45 included in frame main body 11.

Moreover, central controller 341 may control components included in rotor units 20, such as motors 22, either via unit controller 241 or directly.

Other components and operations of the aircraft according to Embodiment 3 are the same as described in Embodiment 1, and as such, description thereof is omitted. Furthermore, the aircraft according to Embodiment 3 achieves the same advantageous effects as aircraft 100 according to Embodiment 1. Still furthermore, with the aircraft according to Embodiment 3, units 100a, 100b, 100c, and 100d each include unit controller 241 that controls rotor unit 20, and unit 100e includes central controller 341 that controls units 100a, 100b, 100c, and 100d connected to unit 100e so as to operate cooperatively. With the above-described configuration, when units 100a, 100b, 100c, and 100d are separated from unit 100e, each is individually capable of flight as a single, compact aircraft. When units 100a, 100b, 100c, and 100d are connected to unit 100e, it is possible to achieve an aircraft having a high degree of flying capability.

Note that each unit controller 241 may be configured to receive the control signal from central controller 341 via wireless communications device 44. With such a configuration, when units 100a, 100b, 100c, and 100d are connected to unit 100e, it is possible to omit electrical connection.

### Other Embodiments

The above embodiments have been presented as examples of techniques according to the present disclosure. However, the techniques according to the present disclosure are not limited to the above embodiments; various changes, substitutions, additions, omissions, etc., may be made to the embodiments. Moreover, components included in the above-described embodiments and components included in the other embodiments described below may be combined to achieve new embodiments. Next, other embodiments will be exemplified.

The aircrafts according to Embodiments 1, 2, and 3 described above include shock absorbers implemented as hollow balloons 30 or 230, but these examples are not limiting. For example, a shock absorber may be made of a solid material such as a sponge or rubber. In other words, so long as the shock absorber is made of a material that can absorb a shock when contact is made with an object, the shock absorber may be made using any sort of material.

The aircrafts according to Embodiments 1, 2, and 3 described, above each include a single rotor unit 20 in a single through-hole 30a in each first balloon 30, but this example is not limiting; the aircrafts may include two or more rotor units 20 in a single through-hole 30a in each first balloon 30.

In the aircrafts according to Embodiments 1, 2, and 3 described above, a single first balloon 30 is provided to each of four rotor units 20, but this example is not limiting; each and every rotor unit 20 need not be provided with first balloon 30.

In the aircrafts according to Embodiments 1, 2, and 3 described above, first balloon 30 laterally covers rotor unit 20 from the outside, and second balloon 230 covers the lateral side and bottom of frame main body 11 of frame 10 from the outside, but this example is not limiting. First balloon 30 and second balloon 230 may be arranged in any manner.

For example, first balloon 30 may cover rotor unit 20 from the inside instead of from the outside, and may cover rotor unit 20 from both the outside and inside. Moreover, first balloon 30 may be disposed below and/or above rotor unit 20, may be disposed across the bottom and lateral side of rotor unit 20, may be disposed across the top and lateral side of rotor unit 20, and may be disposed across the top, lateral side, and bottom of rotor unit 20. Second balloon 230 may be arranged below and/or above frame main body 11, and may be arranged only on the lateral side of frame main body 11. Second balloon 230 may be arranged across the top and lateral side frame main body 11, and may be arranged across the top, lateral side, and bottom frame main body 11. Moreover, second balloon 230 may be provided to arms 12 of frame 10 rather than to frame main body 11, and may be arranged from frame main body 11 across arms 12.

In the aircrafts according to Embodiments 1, 2, and 3 described above, a single first balloon 30 is provided to each of four rotor units 20, but two or more balloons may be provided to each rotor unit 20. Moreover, a single second balloon 230 is provided to frame main body 11 of frame 10, but two or more balloons may be provided to frame main body 11 of frame 10. Alternatively, chamber 30b of first balloon 30 may be divided into two or more chambers. Similarly, chamber 230b of second balloon 230 may be divided into two or more chambers. When a balloon includes two or more chambers, all of the gas inside the balloon can be prevented from leaking when the sheet material of the balloon ruptures.

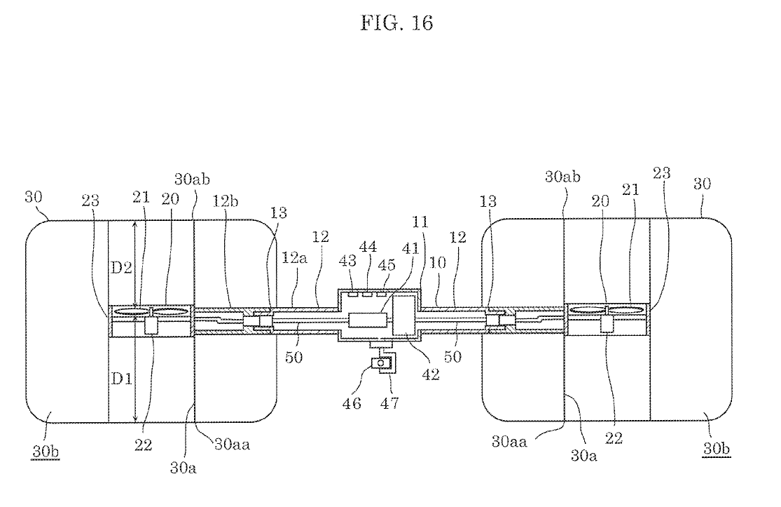

In the aircrafts according to Embodiments 1, 2, and 3 described above, through-hole 30a in first balloon 30 may be configured to have an axial length as illustrated in FIG. 16. FIG. 16 is a cross sectional side view of an aircraft according to a variation of aircraft 100 according to Embodiment 1, similar to the view of FIG. 3. With first balloon 30 in the aircraft illustrated in FIG. 16, rotor unit 20 is arranged such that axial distance D1 of through-hole 30a from open end 30aa of through-hole 30a to propeller 21 of rotor unit 20 is greater than or equal to the inner diameter of through-hole 30a, and axial distance D2 of through-hole 30a from open end 30ab of through-hole 30a to propeller 21 is greater than or equal to the inner diameter of through-hole 30a, In other words, through-hole 30a has an axial length that satisfies the above-described conditions for distances D1 and D2.

Note that inner diameter dimensions of through-hole 30a that are compared to distances D1 and D2 may be the inner diameter dimensions at any section of through-hole 30a; for example, they may be the inner diameter dimensions of open ends 30aa and 30ab. Alternatively, what is compared to distances D1 and D2 may be the outer diameter of rotor frame 23 of rotor unit 20, that is to say, the outer diameter of cylindrical part 23b (see FIG. 4 and FIG. 5). In such cases, rotor unit 20 is arranged such that distances D1 and D2 are greater than or equal the outer diameter of cylindrical part 23b. Moreover, when the edges of the inner perimeter of open ends 30aa and 30ab of through-hole 30a are rounded or chamfered, distances D1 and D2 may be the distances from propeller 21 of rotor unit 20 to planes extending across open ends 30aa and 30ab from the outside of through-hole 30a. When the planes extending across open end 30aa and 30ab are inclined relative to planes perpendicular to the axis of through-hole 30a, distances D1 and D2 may each be a distance from propeller 21 to a point closest to propeller 21 on the plane.

When through-hole 30a has a non-circular cross section, the inner diameter dimensions that are compared to distances D1 and D2 may be, from among the wide variety of crosswise dimensions of cross sections perpendicular to the axis of through-hole 30a, the greatest crosswise dimension. Moreover, distances D1 and D2 may be distances from the center of rotor frame 23 in the axial direction of through-hole 30a, to open ends 30aa and 30ab, respectively.

As described above, first balloon 30 laterally covers rotor unit 20, across a region exceeding the height of rotor unit 20 along the axis of through-hole 30a. First balloon 30 configured in such a manner as to, when a foreign object, such as a person's hand, vegetation, or an object contacts first balloon 30 in the vicinity of open end 30aa or 30ab of through-hole 30a, inhibit foreign objects larger than the inner diameter of through-hole 30a from entering through-hole 30a. In cases in which a foreign object enters through-hole 30a, the size of the section of the foreign object that is inside through-hole 30a is less than or equal to the inner diameter of through-hole 30a. Accordingly, it is possible to prevent such foreign object from contacting propeller 21, which is located at a depth greater than or equal to the inner diameter of through-hole 30a in through-hole 30a. Moreover, when rotor unit 20 is impacted or when rotor unit 20 breaks clown, even if the rotary drive shaft of propeller 21 of rotor unit 20 rotates 90 degrees relative to the axis of through-hole 30a, rotor unit 20 can be inhibited from protruding out of through-hole 30a. Accordingly, first balloon 30 can laterally cover rotor unit 20 to a degree such that rotor unit 20 is not likely to contact an object.

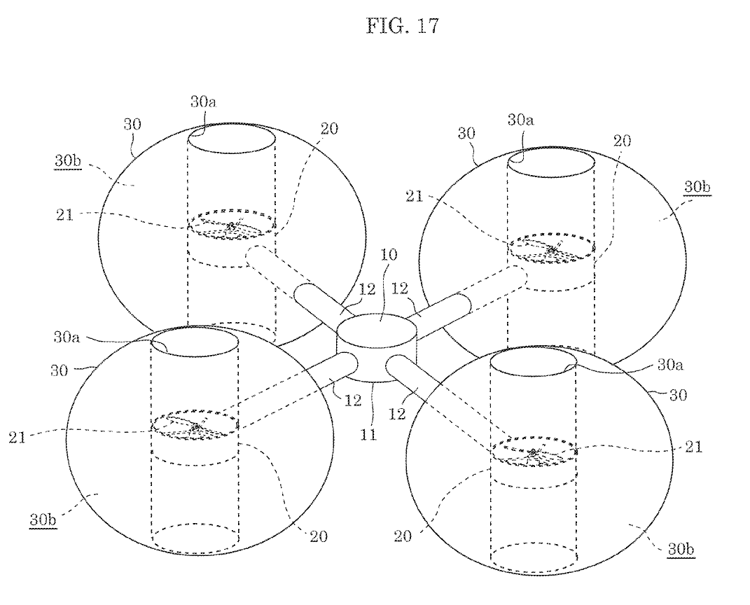

In the aircrafts according to Embodiments 1, 2, and 3 described above, the external shape of each first balloon 30 and second balloon 230 when inflated is exemplified as, but not limited to, a cuboid. The shape of each first balloon 30 and second balloon 230 when inflated may be, for example, a sphere, an ellipsoid, a columnar shape, a polyhedron, or a donut shape, may be any combination of at least two of a sphere, an ellipsoid, a columnar shape, a polyhedron, and a donut shape, and may be any other shape. For example, FIG. 17 illustrates an aircraft including first balloons 30 each having an external shape of an ellipsoid. FIG. 17 is a perspective view of an aircraft according to another variation of aircraft 100 according to Embodiment 1, similar to the view of FIG. 1. Each first balloon 30 illustrated in FIG. 17 has an external shape of an ellipsoid. The ellipsoid is defined by rotating an ellipse about its minor axis that extends along the axis of through-hole 30a. The shape of first balloon 30 is such that its height in the up-and-down direction along the minor axis gradually decreases in a direction from the central region where the minor axis of the ellipsoid is located toward the edge of the ellipsoid at the end of the major axis. With this, since first balloons 30 each have a streamline shape when viewed from the lateral side, it is possible to reduce air resistance. Note that first balloon 30 shaped as illustrated in FIG. 17 can also satisfy the conditions relating to distances D1 and D2 described above with reference to FIG. 16. Note that second balloon 230 may also have an external shape of an ellipsoid.

With the aircrafts according to Embodiments 1, 2, and 3 described above, open ends 30aa and 30ab of through-hole 30a in each first balloon 30 are uncovered, but at least one of open ends 30aa and 30ab may be covered with a protective net. A protective net makes it possible for air to flow in and out of through-hole 30a and for foreign objects to be prevented from entering through-hole 30a, This makes it possible to inhibit damage to propellers 21 of rotor units 20 resulting from contact with a foreign object that has entered through-hole 30a. Furthermore, the length of through-hole 30a may be set such that the distance between the protective net and propeller 21 in through-hole 30a is long enough that the protective net and propeller 21 would not come into contact if first balloon 30 and/or the protective net were to deform.

With the aircrafts according to Embodiments 1, 2, and 3 described above, each arm 12 of frame 10 is configured so as to be, via coupling part 13 located midway on arm 12, separable into first arm part 12a integral with frame main body 11 and second arm part 12b integral with rotor frame 23 of rotor unit 20. However, frame main body 11 and first arm part 12a may be separable from each other. With such a configuration, the size of unit 100e when separated from units 100a through 100d can be further reduced. The coupling part between frame main body 11 and first arm part 12a may employ the same structure as coupling part 13. Alternatively, arm 12 may be configured so as to be separable at a connecting part between arm 12 and rotor frame 23 and at a connecting part between arm 12 and frame main body 11, rather than at coupling part 13. In such cases as well, the same structure as coupling part 13 may be employed at the separable part.

The aircrafts according to embodiments 1, 2, and 3 described above are each exemplified as, but not limited to, including four rotor units 20; each may include one or more rotor units 20.

The above embodiments have been presented as examples of techniques according to the present disclosure. The accompanying drawings and the detailed description are provided for this purpose.

Therefore, the components described in the accompanying drawings and the detailed description include, in addition to components essential to overcoming problems, components that are not essential to overcoming problems but are included in order to exemplify the techniques described above. Thus, those non-essential components should not be deemed essential due to the mere fact that they are illustrated in the accompanying drawings and described in the detailed description.

The above embodiments are for providing examples of the techniques according to the present disclosure, and thus various modifications, substitutions, additions, and omissions are possible in the scope of the claims and equivalent scopes thereof.

### INDUSTRIAL APPLICABILITY

As described above, the present disclosure is applicable to an aircraft including a plurality of rotor units and a balloon.

What is claimed is:

1. An aircraft, comprising:
a plurality of rotor units each including a propeller and a motor that drives the propeller;
a plurality of shock absorbers provided to the plurality of rotor units; and
a main body to which the plurality of rotor units attach,
wherein the plurality of rotor units and the plurality of shock absorbers are attachable to and detachable from the main body.

2. The aircraft according to claim 1, further comprising:
a plurality of first units each including one of the plurality of rotor units and one of the plurality of shock absorbers provided to the one of the plurality of rotor units;
a second unit including the main body; and
a plurality of connecting parts that connect the plurality of first units and the second unit.

3. The aircraft according to claim 2, wherein
the plurality of connecting parts are positioned inside the plurality of shock absorbers.

4. The aircraft according to claim 2, wherein
an area that the second unit occupies in a plan view when separated from the plurality of first units has a shape and a size that fit within an area that one of the plurality of first units occupies in a plan view when separated from the second unit.

5. The aircraft according to claim 2, wherein
the plurality of first units have approximately a same external shape and approximately a same external size.

6. The aircraft according to claim 2, wherein
each of the plurality of first units includes a unit controller that controls the rotor unit included in the first unit, and
the second unit includes a central controller that causes the plurality of rotor units included in the plurality of first units connected to the second unit to operate cooperatively.

7. The aircraft according to claim 2, wherein
the plurality of first units are physically and electrically connected to the second unit by the plurality of connecting parts.

8. The aircraft according to claim 6, wherein
each of the unit controllers wirelessly receives a control signal from the central controller.

9. The aircraft according to claim 1, wherein
the main body includes a shock absorber.

10. The aircraft according to claim 1, wherein
each of the plurality of shock absorbers is a balloon filled with gas.

11. The aircraft according to claim 1, wherein
each of the plurality of shock absorbers laterally covers one of the plurality of rotor units, across a height of the one of the plurality of rotor units in an up-and-down direction.
